(19) United States
(12) Patent Application Publication
(10) Pub. No.: US 2007/0136761 A1
(43) Pub. Date: Jun. 14, 2007

(54) Method and System for Content Distribution and Playback in a Mobile Telecommunication Network

(75) Inventors: Steven Allen Basmajian II, Denton, TX (US); Todd James Omert, Lewisville, TX (US); Maxim Loukianov, Austin, TX (US)

Correspondence Address: HAYNES AND BOONE, LLP, 901 MAIN STREET, SUITE 3100, DALLAS, TX, 75202, US

(73) Assignee: Freelink Wireless Services, LLC, Denton, TX (US)

(21) Appl. No.: 11/566,030

(22) Filed: Dec. 1, 2006

Related U.S. Application Data
(60) Provisional application No. 60/748,228, filed on Dec. 2, 2005.

(51) Int. Cl. H04N 7/173; H04M 1/00; H04N 7/16

(52) U.S. Cl. 725/62; 725/100; 455/550.1

(57) ABSTRACT

A system, method, and computer-readable medium for providing distribution and output of content are provided. Content transmitted to a mobile terminal may comprise textual, graphical, audio, multimedia, or other content that may be configured for automatic output or playback. Output or playback of the content may be made in response to an event, such as a user action or an incoming call. Usage statistics related to output or playback of the content may be accumulated by a mobile terminal and periodically reported to a network entity.

### RELATED APPLICATION DATA

This patent application claims the benefit of provisional U.S. Patent Application Ser. No. 60/748,228, filed Dec. 2, 2005.

### BACKGROUND

The advertisement of goods and services through traditional media such as radio and television is well known. Typically, advertising through traditional media takes the form of commercials which last ten seconds to one minute and which are delivered to the consumer during a television or radio program that the consumer is interested in watching or listening to. Thus, consumers have traditionally viewed or listened to the commercials as a part of the programs. In other words, consumers were not required to actively seek out the advertisements.

However, television and radio advertising have been negatively affected by recent market trends and technological advances. The advent of Digital Video Recorder (DVR) technologies has allowed consumers to record television programs and skip through the commercials. Furthermore, the consumer audience for television commercials has been reduced by the increased number of cable-television channels that are not reliant on commercials. As a result, the effectiveness of television commercials has been dramatically decreased. Radio advertising has been similarly affected by the development of satellite and Internet radio which may not rely on commercials as does terrestrial radio.

More recently, advertising of goods and services has spread to the Internet which affords advertisers more options for reaching consumers because the advertisers are not limited by defined time periods between or during programs as is the case with television and radio advertising. However, Internet advertisers have tended to focus on methods such as spam, email, banner, and pop-up advertisements. Such advertisement mechanisms are often considered disruptive annoying to the consumers and thus ineffective.

The development of mobile telephone technology has afforded advertisers with yet another avenue to reach consumers, and the potential of mobile telephone advertising is substantial due to the fact that people tend to carry mobile telephones with them wherever they go, and thus advertisers have more opportunities to reach consumers. With the advent of Short Message Service (SMS) and MultiMedia Service (MMS) messaging, advertisers have been able to send advertisements to users of mobile telephones, but the users are required to manually check their message “in-boxes” to receive the advertisements. Requiring consumers to proactively seek out advertisements is similar to Internet spam advertising, and inefficient and ineffective for similar reasons.

Embodiments disclosed herein address limitations thus far experienced by mobile advertisers and content providers while exploiting the potential that mobile delivery of content provides.

### BRIEF DESCRIPTION OF THE DRAWINGS

Aspects of the present disclosure are best understood from the following detailed description when read with the accompanying figures, in which:

FIG. 1 is a diagrammatic representation of an embodiment of an exemplary network system in which embodiments may be implemented;

FIG. 2 is a diagrammatic representation of an exemplary embodiment of a content server depicted in FIG. 1;

FIG. 3 is a simplified block diagram of an exemplary mobile terminal in which embodiments may be implemented;

FIG. 4A is a diagrammatic representation of a software configuration of a mobile terminal implemented in accordance with an embodiment;

FIG. 4B is a diagrammatic representation of content that may be delivered to a mobile terminal for playback thereby in accordance with an embodiment;

FIG. 5 is a flowchart of an exemplary content server processing dispatch routine that facilitates content distribution and usage report collection implemented in accordance with embodiments disclosed herein;

FIG. 6 is a flowchart of a mobile terminal content processing routine implemented in accordance with an embodiment;

FIGS. 7A-7D depict diagrammatic representation of exemplary embodiments for content configuration and playback; and

FIG. 8 is a diagrammatic representation of an exemplary content menu that may be used to index content received by the mobile terminal and stored thereby in accordance with embodiments.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Embodiments disclosed herein provide a method of mobile content delivery, such as advertisement content, that does not require proactive participation on the part of the consumer. In accordance with more specific aspects of embodiments disclosed herein, mobile terminal users may be offered a predetermined amount of cost free minutes, cost free text messages, discounted minutes and/or text messages, or other cost free or reduced fee services for use of mobile wireless telephones (also referred to herein as mobile terminals) in exchange for allowing content providers to send content directly to the users' mobile wireless telephones.

In various illustrative examples depicted and described herein, content delivered to a mobile terminal, playback thereof, and collection of usage statistics related thereto are described relative to advertisement content. However, implementation of embodiments described herein is not limited to any particular type of content, and content other than advertisement content may be suitably substituted therefore. The description of distribution and playback of advertisement content is provided to facilitate an understanding of embodiments disclosed herein. As referred to herein, an advertisement may comprise content that may provide a notification, promotion, or other informational content of a product, service, or other consumer good as well as supplementary information, and may also refer to the general promotion of consumption of other material that may not be directly related with the product. For example, an advertisement may comprise content related to a consumer good, and may additionally include, or be associated with, content that is not directly related to the consumer good, such as entertainment content.

In accordance with broader aspects of embodiments disclosed herein, mechanisms are provided for incorporating software that overlays the existing operating systems of mobile wireless telephones to receive advertisements that are sent directly into the mobile wireless telephones from central servers to be viewed by the users. The operating system of a mobile wireless telephone may be implemented in software, hardware, firmware, or a combination thereof. Examples of usable space within mobile terminals for placing advertisements are ring tones, animations, coupons, interactive games, text in SMS messages, background or wallpaper screens, and images within MMS messages. Regardless of how or where the content is placed on the mobile terminals, the content may be automatically viewable by the mobile terminal users without requiring any manual action on behalf of the users.

The software that overlays the operating system tracks the usage of the mobile terminals and stores the usage results in databases or file storage of the mobile terminal. The software may also send information in the mobile terminal to a central server where it is accessible to advertisers. The content providers, such as advertisers, may base the types of content that are sent out, and the recipients to whom the content is sent, at least partially on the tracked information. The types of information that may be tracked include i) the times when the mobile terminal is opened or powered on, ii) when a phone book of the mobile terminal is accessed, iii) when calls are placed and the duration thereof, iv) when calls are received and the duration thereof, v) the length of the ringing when calls are received, vi) games that are accessed, vii) other menus that are accessed, viii) whether users follow through with an advertisement or other content, and ix) the total number of content or advertisements viewed.

Embodiments disclosed herein provide software that is placed on central servers that send advertisements or other content out to mobile terminals and that receive information on consumer use. The central servers may store the information in databases that are accessible to advertisers. The software that is utilized by the central servers also allows the central servers to maintain databases of customer information that can be cross-referenced with the information that is kept regarding the customers use of the mobile terminal.

Embodiments disclosed herein may take advantage of existing mobile wireless telephone infrastructure for sending advertisements to mobile wireless telephones and sending customer tracking or usage information back to the central servers.

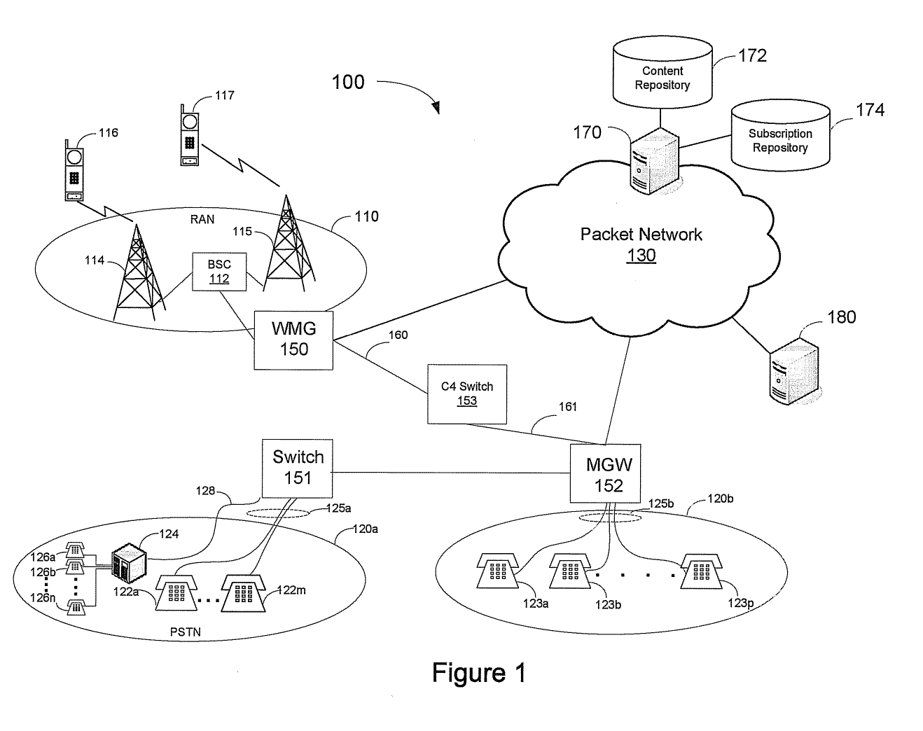

FIG. 1 is a diagrammatic representation of an exemplary network system 100 comprising wireless, wireline, e.g., PSTN and packet networks in which embodiments disclosed herein may be implemented. System 100 may include several networks and/or portions of networks interconnected by various infrastructure. In the illustrative example, system 100 includes a radio access network 110, public switched telephone network (PSTN) access networks 120a-120b, and a packet network 130, e.g., the Internet.

Radio access network (RAN) 110 may include a base station controller (BSC) 112 that is coupled with one or more base transceiver stations (BTSs) 114-115 that provide an over-the-air interface with one or more wireless mobile terminals 116-117. BTSs 114-115 include equipment for transmitting and receiving radio signals with mobile terminals 116-117. BTSs 116-117 may be adapted to encrypt and decrypt communications made with BSC 112 which may provide control to a plurality of BTSs. In the illustrative example, BSC 112 interfaces with a switching wireless media gateway (WMG) 150 that provides for communications between devices in RAN 110 with other access networks, such as PSTN access networks 120a-120b and packet network 130. RAN 110 and WMG 150 may comprise part of a cellular or mobile telecommunications network, such as a network compliant with the Global System for Mobile (GSM) communications standards, Universal Mobile Telecommunications System (UMTS), or another mobile or cellular radio system. Mobile terminals may comprise cellular telephones or smart phones, personal digital assistants (PDAs), multi-mode terminals, or another suitable communication device adapted to transmit and receive communications in RAN 110 or another suitable wireless or wired network system. PSTN access network 120a may include various devices, such as residential telephones 122a-122m, and/or one or more private branch exchanges (PBXs) 124. PBX 124 may connect with switch 151 via one or more trunk lines 128. Various devices 126a-126n, such as telephones, communication terminals, facsimile machines, and the like, may be connected with PBX 124. Residential telephones 122a-122m may be coupled with switch 151, such as a class 5 switch, that may be deployed as a central office by local loops 125a. In other implementations, telephones 122a-122m may be coupled with switch 151 by digital loop carriers, PBXs, digital concentrators, and/or other aggregators, or may otherwise be configured to communicate with switch 151 through PSTN access network 120a. Loops 125a may include digital loops and/or analog loops, and may be configured to transmit time-division multiplexed (TDM) and other PSTN data, among others. Loops 125a may comprise, for example, a respective twisted copper pair terminating telephones 122a-122m.

In a similar manner, PSTN access network 120b may include a variety of communication devices 123a -123p that may be interconnected with a switching media gateway (MGW) 152 via local loops 125b or other suitable couplings. In this implementation, media gateway 152 may provide switching services and media handling across various platforms. Accordingly, MGW 152 may interface with one or more network types, such as PSTN access network 120b and packet network 130. In other implementations, MGW 152 may interface with a RAN and thus may include one or more wireless network interfaces. Moreover, MGW 152 may provide both Class 4 and Class 5 switching services and thus may aggregate traffic from other network entities, such as switch 151 interconnected therewith, and may provide switching services to termination points in networks 120b and 130.

Packet network 130, such as the Internet or another packet switching network, may include interconnected computer networks, data processing systems, communication devices, packet switching infrastructure, and the like. Packet network 130 may interface with one or more switches, such as switching MGW 152. In the illustrative example, MGW 152 interfaces with PSTN access network 120b and packet network 130, and thus may include both TDM switching and packet switching capabilities.

Switch 153 may aggregate traffic from any number of telecommunication nodes, such as MGWs 150 and 152 connected therewith via respective trunks 160 and 161, other network switches, and the like, and thus may be implemented as a Class 4 switch. Accordingly, any device in RAN 110, PSTN access networks 120a and 120b, and packet network 130 may communicate with any other device in RAN 110, PSTN access networks 120a and 120b, and packet network 130.

In accordance with embodiments disclosed herein, a content server 170 may be deployed in system 100, e.g., in packet network 130. Content server 170 may include or interface with a content repository 172 in which content, such as advertisement content, gaming content, information content, entertainment content, or other data, that may be transmitted to one or more mobile terminals 116-117 is stored. Moreover, content server 170 may collect usage statistics related to recipients of content as described more fully hereinbelow.

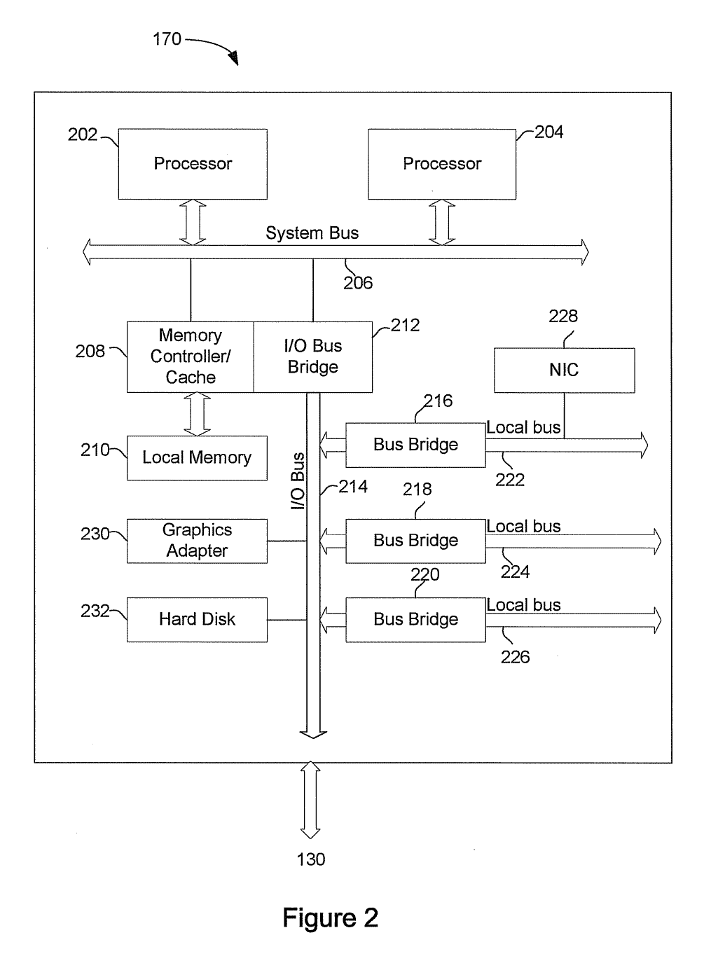

FIG. 2 is a diagrammatic representation of an exemplary embodiment of content server 170 depicted in FIG. 1. Code or instructions implementing embodiments disclosed herein may be located or accessed by server 170.

Server 170 may be implemented as a symmetric multiprocessor (SMP) system that includes a plurality of processors 202 and 204 connected to a system bus 206, although other single-processor or multi-processor configurations may be suitably substituted therefore. A memory controller/cache 208 that provides an interface to local memory 210 may also be connected with system bus 206. An I/O bus bridge 212 may connect with system bus 206 and provide an interface to an I/O bus 214. Memory controller/cache 208 and I/O bus bridge 212 may be integrated into a common component.

A bus bridge 216, such as a Peripheral Component Interconnect (PCI) bus bridge, may connect with I/O bus 214 and provide an interface to a local bus 222, such as a PCI local bus. Communication links to other network nodes of system 100 in FIG. 1 may be provided through a network interface card (NIC) 228 connected to local bus 222 through add-in connectors. Additional bus bridges 218 and 220 may provide interfaces for additional local buses 224 and 226 from which peripheral or expansion devices may be supported. A graphics adapter 230 and hard disk 232 may also be connected to I/O bus 214 as depicted.

An operating system may run on processor system 202 or 204 and may be used to coordinate and provide control of various components within server 170. Instructions for the operating system and applications or programs are located on storage devices, such as hard disk drive 232, and may be loaded into memory 210 for execution by processor system 202 and 204.

Those of ordinary skill in the art will appreciate that the hardware depicted in FIG. 2 may vary. The depicted example is not intended to imply architectural limitations with respect to implementations of the present disclosure.

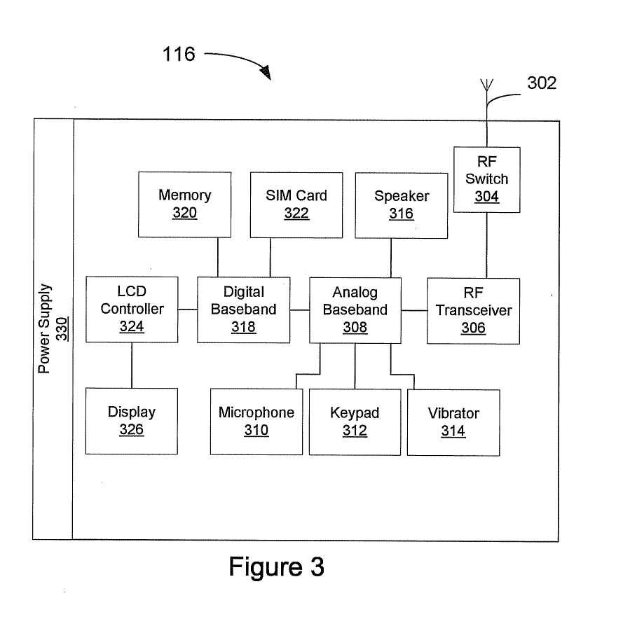

FIG. 3 is a simplified block diagram of an exemplary mobile terminal 116 in which embodiments may be implemented. Mobile terminal 116 includes an antenna 302 that may be coupled with a RF switch 304, e.g., a duplexer, coupled with an RF transceiver 306. Transceiver 306 may be coupled with an analog baseband 308 that may handle a variety of analog signal processing functions. In the present example, analog baseband 308 is interconnected with a microphone 310, a keypad 312, a vibrator 314 or other ring alert mechanism, and a speaker 316. Analog baseband 308 may include or interface with an analog to digital converter for converting analog input supplied to microphone 310 into a digital format that may be supplied to a digital baseband 318. Digital baseband 318 may interface with various digital components of mobile terminal 116, such as a memory 320, subscriber identity module (SIM) 322, and a liquid crystal display controller 324 that drives a display 326. Digital baseband 318 may additionally include or interface with one or more encoders, digital to analog converters, or other modules. A power supply 330 may be coupled with various system modules as is understood.

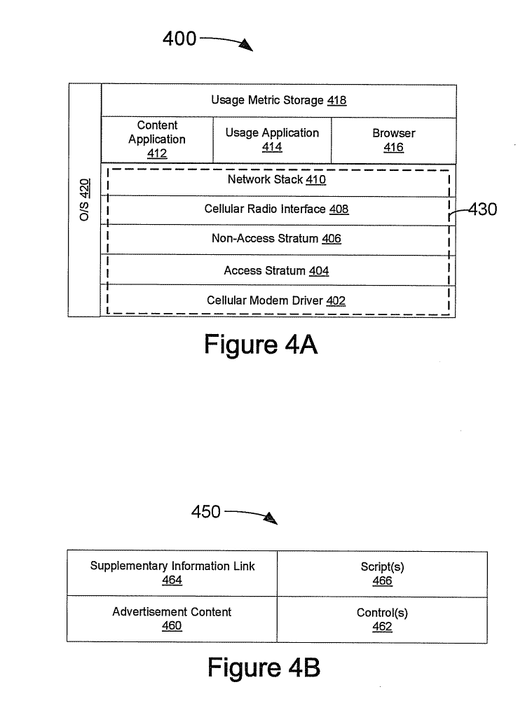

FIG. 4A is a diagrammatic representation of a software configuration 400 of a mobile terminal implemented in accordance with an embodiment. In the exemplary configuration of FIG. 4A, the mobile terminal is configured with access network-specific software entities 430, e.g., protocol and driver software associated with a particular access network technology such as GSM, UMTS, or another suitable radio access network, and is dependent on the particular cellular or communication network in which the mobile terminal is to be deployed. While the configuration 400 depicts a mobile terminal adapted for deployment in a single access network technology type, the mobile terminal may be implemented as a multi-mode device and may accordingly include a plurality of access-specific entities. The particular configuration 400 is illustrative only and is provided only to facilitate an understanding of embodiments disclosed herein.

In the present example, configuration 400 includes a cellular modem driver 402 for providing a physical interface with the access network in which the mobile terminal is deployed. An access-stratum 404 and a non-access stratum 406 may be included in configuration 400. A cellular radio interface 408 may be communicatively coupled with lower layers of configuration 400 and may additionally interface with network and session management layers, e.g., a network stack 410 such as a Transmission Control Protocol/Internet protocol (TCP/IP) stack.

A content application 412 is adapted to receive digital content received by the mobile terminal and automatically playback received content. Playback of received content may be made via visual display, audio playback, or visual and audio playback dependent on the particular content.

A usage application 414 is adapted to monitor usage characteristics of the mobile terminal and/or content usage metrics. Usage application 414 is depicted as an application separate from content application 412 although usage application 414 may be implemented as one or more subroutines or processes of content application 412. Additionally, configuration 400 may include a browser 416 or other communication application. Accordingly, content received and displayed by the mobile terminal may include links to one or more entities, such as web servers, through which a user may connect via a content control, such as a hyperlink, displayed or otherwise included in received content. A usage metric storage 418 may be included in configuration 400 for storing usage metrics accumulated by usage application 414. Usage metrics may be stored as files stored in usage metric storage 418. Additionally, configuration 400 may include an operating system 420, such as Linux, Symbian, or another operating system suitable for mobile applications, and may coordinate and provide control of various components within the mobile terminal.

In accordance with an embodiment, content, such as advertisement content, may be created and supplied to content server 170. Content server 170 includes or interfaces with a content repository 172, such as one or more databases. The digital advertisements or other content may take the form of ringtones, animations, coupons, barcodes, interactive games, text, background screens, images, or other suitable media. Creation of the digital advertisements may be made according to any variety of mechanisms well known in the art.

Digital advertisements or other content may then be transmitted from server 170 to mobile terminals, such as one or more of mobile terminals 116-117 depicted in FIG. 1. The digital advertisements or other content may be sent to mobile terminals via any one of various mechanisms, e.g., in-band on a voice channel or on a suitable data channel. In the event the mobile terminal is adapted to receive content over a plurality of channels or interfaces, one or more particular channels for delivery of content to the mobile terminal may be selected based on, for example, delivery speed of the channel, the cost of delivery associated with the channels, or by other channel selection criteria.

The digital advertisements or other content may then be displayed on the mobile terminals automatically. Users of mobile terminals are not required to manually look for or otherwise open the digital advertisements or content that are sent to the mobile terminals in accordance with embodiments. Rather, content application 412 run by a host mobile terminal is automatically invoked for display or playback of any received advertisement or other content.

In accordance with another embodiment, usage metrics may be recorded by a mobile terminal that has received a digital advertisement or other content. Exemplary types of activities that may be recorded include, but are not limited to, a time at which the mobile terminal is powered on, a time when a phone book of the mobile terminal is accessed, times when calls are placed from the mobile terminal and durations of placed calls, times at which calls are received by the mobile terminal and durations of received calls, the length of ringing when calls are placed to the mobile terminal, games that are accessed by the mobile terminal, menus accessed on the mobile terminal, user-follow through statistics related to digital advertisements, an advertisement count that accumulates a number of advertisements viewed on the mobile terminal, or other usage metrics.

Usage metrics may be compiled by software resident on the mobile terminal. Software hosted by the mobile terminal may be responsible for acquiring usage metrics and compiling the usage metrics into a usage report that may be stored in a memory of the mobile terminal. The usage report may be periodically transmitted to content server 170 or another suitable processing entity for evaluation of the usage metrics. The content server may then store the usage metric report for later evaluation. Usage metric reports received and stored by content server 170 may then be used for applying tariffs or credits to a user of the mobile terminal, applying charges to advertisers for which one or more advertisements were viewed by the mobile terminal, or for other uses.

FIG. 4B is a diagrammatic representation of content 450 that may be delivered to a mobile terminal for playback thereby in accordance with an embodiment. In the illustrative example, content 450 may comprise advertisement content 460, such as textual content, graphical content, audio content, or video content. In other implementations, advertisement content 460 may comprise an application, such as a game that may be executed on the mobile terminal. Additionally, content 450 may optionally comprise one or more controls 462, such as hyperlinks or other user-selectable controls. In the event that the control 462 comprises a hyperlink, selection thereof by a user may result in establishment of a session with a server, such as server 180 depicted in FIG. 1, that may convey one or more web pages including additional advertisement content, applications, or other supplementary content to the mobile terminal. The supplementary content may comprise, for example, a web page that prompts the user for additional input. For example, assume that the advertisement content comprises an advertisement for a credit card. Control 462 may link to a web page that is displayed by browser 416 that prompts the user for additional information regarding the user. In other implementations, the control may link to supplementary information that is locally stored by the mobile terminal. In this manner, selection of the control may provide immediate interaction with additional content, e.g., other textual, graphical, audio or video content, that is stored by the mobile terminal. Additionally, content 450 may optionally include a supplementary information link 464, e.g., a URL of a network server such as server 180 depicted in FIG. 1 or a logical link to other content stored by the mobile terminal. The information link 464 may be associated with a corresponding control 462 such that selection of the control results in activation of the associated link. Additionally, content 450 may optionally include a script 466 that comprises logic for processing input, such as user selection of a control in content 450, supplied to the mobile terminal, that facilitates playback of supplementary information (either stored locally in the mobile terminal or that is accessed by the mobile terminal), or that provides other functionality associated with playback of content 460.

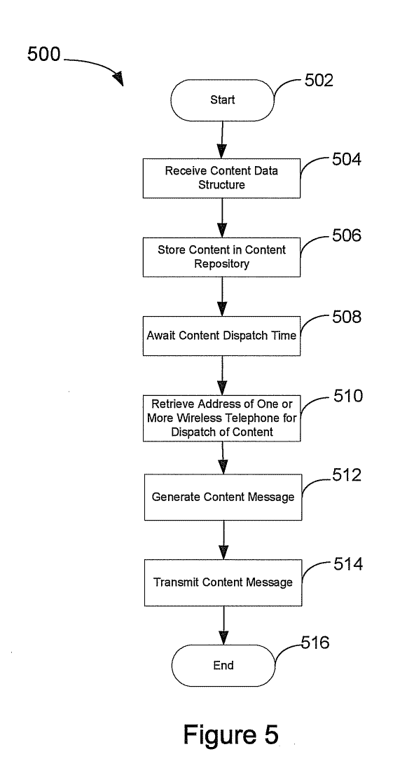

FIG. 5 is a flowchart 500 of an exemplary content server processing dispatch routine that facilitates content distribution and usage report collection implemented in accordance with embodiments disclosed herein.

The server processing routine is invoked (step 502), and one or more content data structures are received by content server 170 (step 504). Content server 170 may store the received content in content repository 172 (step 506). One or more addresses of mobile terminals to which content is to be dispatched is then retrieved (step 508). The addresses of one or more mobile terminals to which content is to be dispatched may comprise, for example, a respective telephone number assigned to the mobile terminals. Content server 170 may include or interface with subscription repository 174 that maintains records of subscriptions to the content service provided by content server 170. Subscription repository 174 may include records that respectively identify a user, mobile terminal phone number, and other subscription characteristics for users that have subscribed to receive content via the subscribers' mobile terminals. Content server 170 may then generate a message including content stored in content repository 172 to the one or more mobile terminals for which addresses have been retrieved (step 512). For example, assuming the content comprises advertisement content, an advertisement message may be generated as one or more TCP/IP packets associated with content application 412. The association made between the advertisement message and content application 412 may be made via a port designation in the IP packet that is associated with application 412. Content server 170 may then dispatch the generated advertisement message (step 514). The content server dispatch processing routine cycle may then end (step 516).

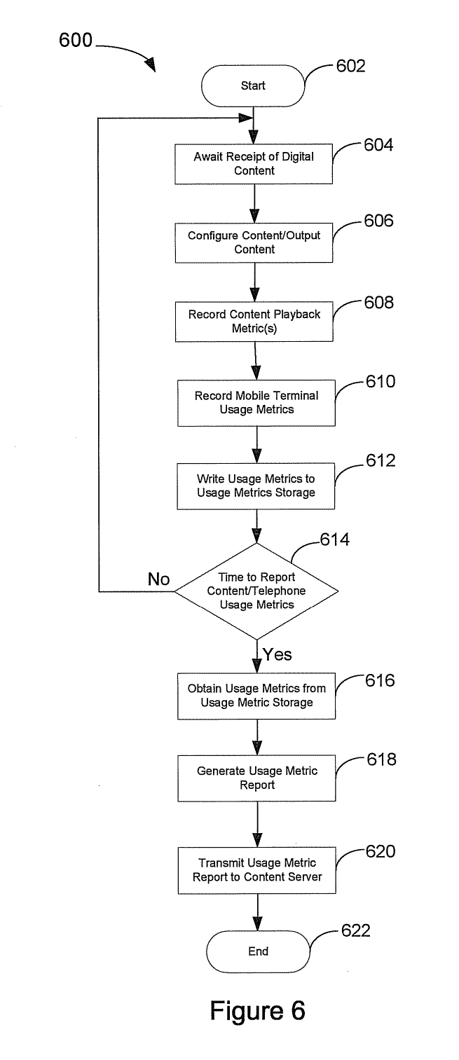

FIG. 6 is a flowchart 600 of a mobile terminal content processing routine implemented in accordance with an embodiment.

The content processing routine is invoked (step 602), and the content application awaits receipt of content (step 604). On receipt of the content, the content is configured for playback and output or otherwise played by content application 412 (step 606). In other implementations, the content may be configured for automatic playback in response to a particular event, such as powering on of a display screen, receipt of a call, or the like. One or more metrics or characteristics of the content playback may then be recorded (step 608). For example, an identifier of the content, such as a file name or code assigned to the content, may be recorded in association with the time of the content playback. In the event the content includes user-selectable options, such as selectable hyperlinks, a usage indication that specifies whether the user selected or “clicked though,” the user-selectable option may be recorded. In other implementations, content may provide an immediate interactivity option to other content located on the mobile terminal. For example, content implemented as a text-based, graphical-based, audio and/or video-based content may be associated with additional content located on the mobile terminal. Selection of the content or a control thereof by the user may result in immediate invocation of playback of the associated content. In this implementation, a usage indication may be recorded that specifies playback of the associated content. The usage indication may include, for example, the time and date of playback, the type of playback (e.g., as a background or wallpaper image, a ring tone, an application, or other output), an identity of the user associated with the mobile terminal, a counter value that records the number of times the content has been output, and/or other usage indicators. Various other wireless telephone usage metrics or characteristics may also be recorded (step 610). The content usage metric and/or mobile terminal usage metrics may then be recorded in usage metric storage 418.

On recordation of the content usage metrics and/or telephone usage metrics, the usage metrics may be stored in usage metrics storage 418 (step 612). A periodic evaluation may be made to determine if the usage metrics are scheduled to be reported, e.g., to content server 170 (step 614). In the event that the usage metrics are not yet scheduled to be reported, the content processing routine may return to step 604 to await receipt of other content. Upon determining that the usage metrics are scheduled to be transmitted to the content server or another suitable entity, the content processing routine may obtain the usage metrics from the usage metrics repository (step 616) and generate a usage metrics report (step 618). The usage metrics report may optionally be signed, and the usage metrics report may then be transmitted to the content server or another suitable entity (step 620). The advertisement processing routine cycle may then end (step 622).

It is important to note that the display or playback of the content depicted at step 606 may be delayed until a suitable event. For example, if content comprising an advertisement that is to be output as a background screen on the receiving mobile terminal is received when the screen is not active, the content application may configure the received content as a background image of the mobile terminal screen, and playback of the content may not occur until the screen is activated, e.g., when a phone call is received, when a key of the mobile terminal is depressed, or another event that results in activation of the mobile terminal screen. As another example, the content may comprise audio content that is configured by content application 412 as a ring tone. In this instance, the content is automatically configured for output, and the content will be output on receipt of an incoming call by the mobile terminal.

In one embodiment, content delivered to a mobile terminal may comprise advertisement content and may be delivered to mobile terminals via various mechanisms. For example, advertisements may be delivered to a mobile terminal by way of short message services (SMS), MMS and general packet radio services (GPRS), Bluetooth for proximity-based services, or by other suitable mechanisms.

Content application 412 and/or usage application 414 may be deployed on mobile terminal SIM 322. In other implementations, content application 412 and/or usage application 414 may be delivered over an air-interface to a mobile terminal and may be stored in mobile terminal memory 320.

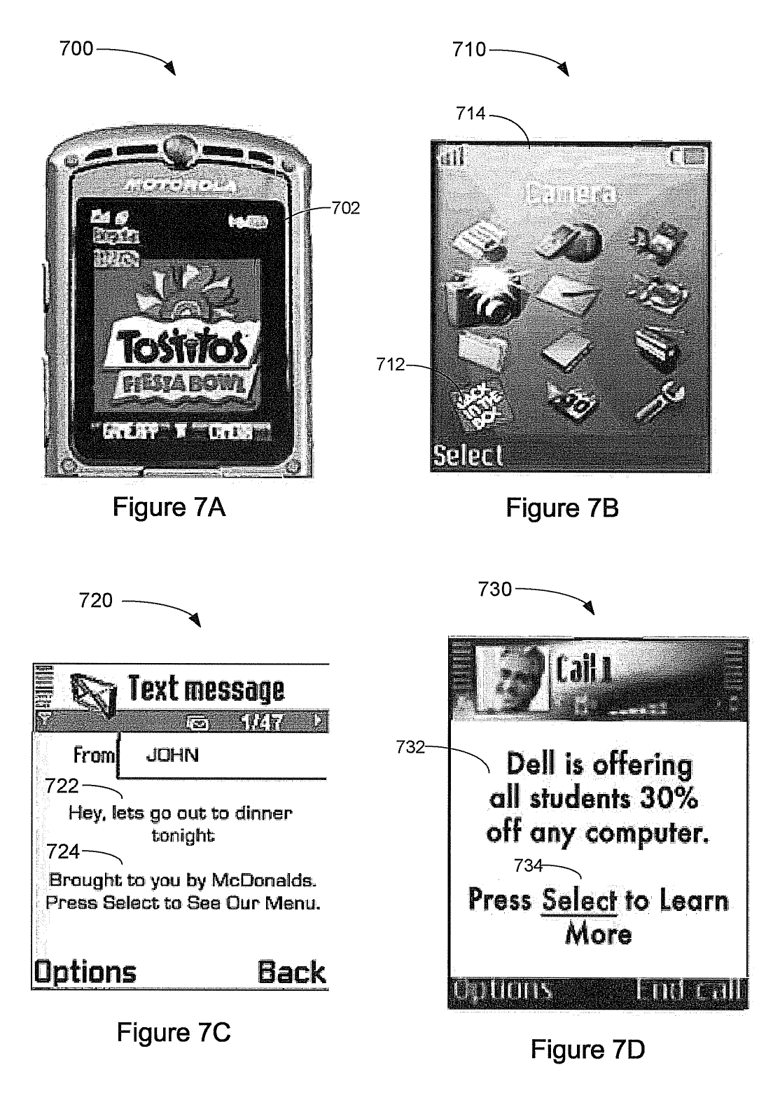

FIGS. 7A-7D depict various exemplary implementations for advertisement playback and configuration in accordance with embodiments. FIG. 7A is a diagrammatic representation of a mobile terminal display device, such as display 326, on which exemplary graphical content may be output by a mobile terminal. In the present example, an advertisement comprising visual advertisement content may be transmitted to the mobile terminal and received by content application 412. Content application 412 may then configure the advertisement for automatic output or playback. In the present example, the advertisement content may be configured as a background image 702 displayed on display 326. Thus, each time the user opens the phone (in the case that the mobile terminal comprises a flip or clamshell phone) or otherwise performs an event that results in screen activation, the advertisement is displayed. In this manner, the advertisement may be displayed when the user is entering a phone number in preparation for making a phone call, when the mobile terminal is receiving a phone call, and when the user activates the screen for navigating to any of a variety of applications.

FIG. 7B is a diagrammatic representation of a mobile terminal display device, such as display 326, on which exemplary graphical content may be output by a mobile terminal in accordance with an embodiment. In the present example, an advertisement comprising visual advertisement content may be transmitted to the mobile terminal and received by content application 412. Content application 412 may then configure the advertisement for automatic output or playback. In the present example, the advertisement content may be configured as an icon 712 displayed on background 714 displayed on display 326. In this manner, the advertisement icon may be viewed each time the mobile terminal display device is activated, e.g., each time the user opens the phone, when the user enters phone numbers in preparation for making a phone call, when the mobile terminal is receiving a phone call, and when the user activates the screen for navigating to any of a variety of applications.

Moreover, in the example, depicted in FIG. 7B, the advertisement content may additionally include additional content that is displayed or otherwise output in response to selecting a content control configured as an icon 712. For example, selection of icon 712 may result in invocation of browser 416 connecting with a website, e.g., hosted by server 180 depicted in FIG. 1, associated with icon 712. In this manner, selection of icon 712 may result in delivery of additional advertisement or other supplementary content, such as audio, video, graphical, textual, or entertainment content that may be displayed as a web page output by browser 416. In other implementations, additional content associated with icon 712 may comprise audio content, video content, multimedia content, textual or entertainment content that is stored by the mobile terminal and that may be immediately output in response to selection of icon 712.

FIG. 7C is a diagrammatic representation of a mobile terminal display device, such as display 326, on which exemplary graphical content may be output by a mobile terminal in accordance with an embodiment. In the present example, an advertisement comprising textual advertisement content may be transmitted to the mobile terminal and received by content application 412. Content application 412 may then configure the advertisement for automatic output or playback. In the present example, the advertisement content 724 comprising textual content may be configured for display in a text message 722 output on display 326. In this manner, the advertisement content is automatically displayed in response to the user opening a text message. Advertisement application 412 may append advertisement content 724 to text of a text message in response to a user selecting a text message for display.

FIG. 7D is a diagrammatic representation of a mobile terminal display device, such as display 326, on which exemplary graphical content may be output by a mobile terminal in accordance with an embodiment. In the present, example, an advertisement comprising visual advertisement content may be transmitted to the mobile terminal and received by content application 412. Content application 412 may then configure the advertisement for automatic output or playback. In the present example, the advertisement content may comprise textual content 732 that is output on display 326, e.g., when the display is activated. For example, advertisement textual content 732 may be output on display 326 when the user opens the phone, receives a call, of otherwise activates the screen. In the present example, advertisement textual content is output on display 326 when display 326 is activated in response to an incoming call.

Additionally, textual advertisement content 732 may include a user-selectable control 734 or other element which may be selected by the user to obtain additional information, such as additional advertisement content or supplementary content. In the present example, control 734 may comprise a hyperlink that, when selected, may result in invocation of a browser and establishment of a connection with a server or other data processing system. Alternatively, control 734 may comprise a logical link to other content, such as audio, video, or other multimedia content, stored by the mobile terminal, and selection of control 434 may invoke playback of the audio, video, or multimedia file.

The exemplary advertisement outputs depicted in FIGS. 7A-7D are illustrative only and are provided only to facilitate an understanding of embodiments. Various other advertisement output configurations may be provided. For example, advertisement content may comprise audio files that are configured as ring tones such that the advertisement content is automatically output on speaker 316 in response to an incoming call.

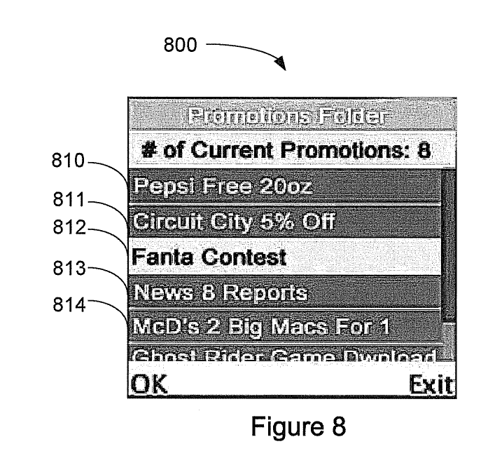

In accordance with another embodiment, content received by a mobile terminal may be stored in memory 320 and content application 412 may generate a menu associated with the stored content. FIG. 8 is a diagrammatic representation of an exemplary content menu 800 that may be used to index content received by the mobile terminal and stored thereby in a memory, such as memory 320 of the mobile terminal. In the present example, menu 800 comprises various user-selectable menu items 810-814 that each may be associated with respective content stored in memory 320. Content application 412 may invoke playback of content associated with a particular menu item in response to user-selection of the menu item. The content may comprise textual, graphical, audio, video, other multimedia, or a combination thereof. In other implementations, a uniform resource locator (URL) of a network entity, such as a server, may be associated with a menu item, and selection of the menu item may result in invocation of browser 416 and establishment of a session with the server. Accordingly, a web page comprising additional content or other information may be transmitted to the mobile terminal and displayed in browser 416 in response to selection of a menu item from content menu 800.

As described, a system, method, and computer-readable medium for providing distribution and output of advertisement or other content are provided. Content transmitted to a mobile terminal may comprise textual, graphical, audio, multimedia, or other content that may be configured for automatic output or playback. In other implementations, output or playback of the content may be made in response to an event, such as a user action. In other implementations, output or playback of content may be made in response to an event, such as an incoming call. Usage statistics related to output or playback of content may be accumulated by a mobile terminal and periodically reported to a network entity. Mobile terminal users may be provided account credits, such as airtime minutes, text message credits, reduced-rate airtime, text, or other services, or other usage credits based on the amount of content output on the user's mobile terminal. Usage credits, such as airtime minutes, text messages, or other service credits may be based on the particular content type, duration of playback and/or other metrics recorded for the content playback. For example, output of content configured as a background of a mobile terminal may be assigned a first pre-defined airtime, text, or other service credit, whereas playback of content configured as an interactive application, audio, video, or other content may be assigned a second pre-defined airtime, text, or other service credit.

The flowcharts of FIGS. 5-6 depict process serialization to facilitate an understanding of disclosed embodiments and are not necessarily indicative of the serialization of the operations being performed. In various embodiments, the processing steps described in FIGS. 5-6 may be performed in varying order, and one or more depicted steps may be performed in parallel with other steps. Additionally, execution of some processing steps of FIGS. 5-6 may be excluded without departing from embodiments disclosed herein. The illustrative block diagrams and flowcharts depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like.

Aspects of the present invention may be implemented in software, hardware, firmware, or a combination thereof. The various elements of the system, either individually or in combination, may be implemented as a computer program product tangibly embodied in a machine-readable storage device for execution by a processing unit. Various steps of embodiments of the invention may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying the aspects of the present invention can be loaded onto a computer, mobile terminal, or other instruction execution system. The computer program is not limited to any particular embodiment, and may, for example, be implemented in an operating system, application program, foreground or background process, driver, network stack, or any combination thereof, executing on a single computer processor or multiple computer processors. Additionally, various steps of embodiments of the invention may provide one or more data structures generated, produced, received, or otherwise implemented on a computer-readable medium, such as a memory.

Although embodiments of the present disclosure have been described in detail, those skilled in the art should understand that they may make various changes, substitutions and alterations herein without departing from the spirit and scope of the present disclosure.

What is claimed is:

1. A method of displaying content, comprising:
transmitting digital content over a wireless interface to a mobile terminal;
storing the content in a memory of the mobile terminal; and
automatically outputting the content on an output device of the mobile terminal.

2. The method of claim 1, wherein transmitting digital content comprises transmitting an advertisement comprising at least one of text contents audio content, video content, and audio and video content.

3. The method of claim 1, wherein the digital content comprises image content, and wherein automatically outputting the content comprises displaying the image content as a background of the mobile terminal.

4. The method of claim 1, wherein the digital content comprises image content, and wherein automatically outputting the content comprises displaying the image content as an icon on a screen of the mobile terminal.

5. The method of claim 1, wherein the digital content comprises audio content, and wherein automatically outputting the content comprises playing the audio content on a speaker of the mobile terminal.

6. The method of claim 1, wherein the digital content comprises audio content, the method further comprising configuring the audio content as a ring tone, and wherein automatically outputting the content comprises playing the ring tone in response to receiving a call by the mobile terminal.

7. The method of claim 1, wherein the digital content comprises multimedia content comprising video and audio content, and wherein automatically outputting the content comprises displaying the video on a display of the mobile terminal and outputting the audio on a speaker of the mobile terminal.

8. The method of claim 1, further comprising receiving a user selection of a control associated with the content.

9. The method of claim 8, wherein the control comprises a hyperlink in the content, the method further comprising:
invoking a browser hosted by the mobile terminal; and
connecting with a web site associated with the hyperlink.

10. The method of claim 1, wherein the digital content comprises first audio content, the method further comprising:
configuring the first audio content as a ring tone;
receiving second digital content comprising second audio content; and
configuring the second audio content as a ring tone after playback of the first audio content.

11. The method of claim 1, wherein transmitting further comprises transmitting the content via one or more of a plurality of channels.

12. The method of claim 11, wherein the one or more channels are selected based on at least one of a delivery speed of the one or more channels and the cost of delivery of the one or more channels.

13. The method of claim 1, wherein transmitting further comprises transmitting the content via a mechanism selected from the group consisting of short message service, multimedia service, wireless access protocol, and general packet radio service.

14. The method of claim 1, further comprising reporting delivery of the content to a network entity.

15. The method of claim 14, wherein reporting delivery of the content further comprises reporting one or more of an originator of the content, and time and date of transmission of the content to the mobile terminal.

16. The method of claim 1, further comprising generating one or more usage statistics related to output of the content.

17. The method of claim 16, wherein the content comprises visual advertisement content displayed on a screen of the mobile terminal and a ring tone output on a speaker of the mobile terminal when a call is placed to the mobile terminal, wherein the one or more usage statistics include an identifier of a visual playback of the visual advertisement content and audio playback of the ring tone when a call is placed to the mobile terminal.

18. The method of claim 16, wherein the content comprises visual advertisement content displayed on a screen of the mobile terminal and a ring tone output on a speaker of the mobile terminal when a call is placed to the mobile terminal, wherein the one or more usage statistics include an identifier of a visual playback of the visual advertisement content of and audio playback of the ring tone when a call to the mobile terminal is answered.

19. The method of claim 16, wherein the content comprises visual advertisement content displayed on a screen of the mobile terminal, wherein the one or more usage statistics include an identifier of a visual playback of the visual advertisement content when a call is placed from the mobile terminal.

20. The method of claim 16, wherein the content comprises multimedia content, and wherein the usage statistic includes an identifier of playback of the multimedia content.

21. The method of claim 1, further comprising:
recording a record of output of the content:
electronically signing the record; and
delivering the signed record to an auditing entity.

22. The method of claim 21, wherein the signed record includes at least one of a time and date when the content was output, an identification of a type of playback of the content, and an identity of a user associated with the mobile terminal.

23. A computer-readable medium having computer-executable instructions for execution by a processing system, the computer-executable instructions for outputting content on a mobile terminal, comprising:
instructions that receive digital content over a wireless interface;
instructions that store the content in a memory of the mobile terminal; and
instructions that configure the content for output on an output device of the mobile terminal.

24. The computer-readable medium of claim 23, wherein the instructions that receive the digital content comprise instructions that receive an advertisement comprising at least one of text content, audio content, video content, audio and video content, and gaming content.

25. The computer-readable medium of claim 23, wherein the content comprises image content, and wherein the instructions that configure the content for output comprise instructions that configure the image content as a background of the mobile terminal.

26. The computer-readable medium of claim 23, wherein the digital content comprises image content, and wherein the instructions that configure the content for output comprise instructions that configure the image content as an icon on a display of the mobile terminal.

27. The computer-readable medium of claim 23, wherein the digital content comprises audio content, and wherein the instructions that configure the content for output comprise instructions that configure the audio content for output on a speaker of the mobile terminal.

28. The computer-readable medium of claim 23, wherein the digital content comprises audio content, the computer-readable medium further comprising instructions that configure the audio content as a ring tone, and wherein the instructions that configure the advertisement for output comprise instructions that configure the audio content for playback of the audio content as the ring tone in response to receiving a call by the mobile terminal.

29. The computer-readable medium of claim 23, wherein the digital content comprises multimedia content comprising video and audio content, and wherein the instructions that configure the content for output comprise instructions that configure the video content for display on a display of the mobile terminal and configure the audio content for output on a speaker of the mobile terminal.

30. The computer-readable medium of claim 23, further comprising instructions that receive a user selection of a control associated with the content.

31. The computer-readable medium of claim 30, wherein the control comprises a hyperlink in the content, the computer-readable medium further comprising:
instructions that invoke a browser hosted by the mobile terminal; and
instructions that connect with a web site associated with the hyperlink.

32. The computer-readable medium of claim 23, wherein the digital content comprises first audio content, the computer-readable medium further comprising:
instructions that configure the first audio content as a ring tone;
instructions that receive second digital content comprising second audio content; and
instructions that configure the second audio content as a ring tone after playback of the first audio content.

33. The computer-readable medium of claim 23, wherein the instructions that receive further comprise instructions that receive the content via one or more of a plurality of channels.

34. The computer-readable medium of claim 33, wherein the one or more channels are selected based on at least one of a delivery speed of the one or more channels and the cost of delivery of the one or more channels.

35. The computer-readable medium of claim 23, wherein the instructions that receive further comprise instructions that receive the content via a mechanism selected from the group consisting of short message service, multimedia service, wireless access protocol, and general packet radio service.

36. The computer-readable medium of claim 23, further comprising instructions that report delivery of the content to a network entity.

37. The computer-readable medium of claim 36, wherein the instructions that report further comprise instructions that report one or more of an originator of the content, and time and date of reception of the content to the mobile terminal.

38. The computer-readable medium of claim 23, further comprising instructions that generate one or more usage statistics related to output of the content.

39. The computer-readable medium of claim 38, wherein the content comprises visual advertisement content displayed on a screen of the mobile terminal and a ring tone output on a speaker of the mobile terminal when a call is placed to the mobile terminal, wherein the one or more usage statistics include an identifier of a visual playback of the visual advertisement content and audio playback of the ring tone when a call is placed to the mobile terminal.

40. The computer-readable medium of claim 38, wherein the content comprises visual advertisement content displayed on a screen of the mobile terminal and a ring tone output on a speaker of the mobile terminal when a call is placed to the mobile terminal, wherein the one or more usage statistics include an identifier of a visual playback of the visual advertisement content of and audio playback of the ring tone when a call to the mobile terminal is answered.

41. The computer-readable medium of claim 38, wherein the content comprises visual advertisement content displayed on a display of the mobile terminal, wherein the one or more usage statistics include an identifier of a visual playback of the visual advertisement content when a call is placed from the mobile terminal.

42. The computer-readable medium of claim 38, wherein the content comprises multimedia content, and wherein the one or more usage statistics includes an identifier of playback of the multimedia content.

43. The computer-readable medium of claim 23, further comprising:
instructions that generate a record of output of the content:
instructions that electronically sign the record; and
instructions that deliver the signed record to an auditing entity.

44. The computer-readable medium of claim 43, wherein the signed record includes at least one of a time and date when the content was output, an identification of a type of playback of the content, and an identity of a user associated with the mobile terminal.
